(19) United States
(12) Patent Application Publication
(10) Pub. No.: US 2010/0301693 A1
(43) Pub. Date: Dec. 2, 2010

(54) ROTATIONAL MAGNETIC PROPULSION MOTORS

(76) Inventor: Daniel Farb, Beit Shemesh (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/740,356

(22) PCT Filed: Oct. 26, 2008
(86) PCT No.: PCT/IB08/54417

§ 371 Date: Apr. 29, 2010

Related U.S. Application Data
(60) Provisional application No. 60/983,240, filed on Oct. 29, 2007.
(60) Provisional application No. 61/017,816, filed on Dec. 31, 2007.

(51) Int. Cl. H02K 47/00; H02K 21/16; H02K 53/00

(52) U.S. Cl. 310/113; 310/156.01; 415/916

(57) ABSTRACT

Devices and methods for generating electricity from configurations of rotors with attached magnets and separate electromagnets are described.

This patent application claims the benefit of U.S. Provisional Patent Application No. 60/983,240, Magnetic Power Generation, filed Oct. 29, 2007, and 61/017,816, Hydro Turbines, Portable Wind, Waves, and Magnets, filed Jan. 1, 2008.

### FIELD AND BACKGROUND OF THE INVENTION

The present inventions relate to systems, devices, and methods for producing electricity from magnetic arrangements.

The best way to do this is to use a technique applied to Maglev propulsion, of alternating charges through electromagnets in order to produce attraction and/or repulsion in nearby magnets on another structure and coordinating this with the distance between the magnets on the other structure. This has not been proposed heretofore for using a rotor to produce electricity. The problem is that the input of electricity will likely be greater than the output. Therefore a way to produce more force from one magnet set versus the other must be found. Two ways of adding this extra force are gravity and superconductivity.

Prior art discusses the maglev concept for use with vehicles, but not with electricity generation, and particularly not with rotors combined with the use of gravitational and superconductive enhancement. The closest prior art with use of a rotor is 2002/0113513 A1, which does not use electromagnets and is a stator/rotor design. The author's own patent, IL2007/000523, discusses the use of magnet sets, but that patent does not claim the use of electromagnets, whereas all the variations in the current application relate to electromagnets as part of the system.

### BRIEF DESCRIPTION OF THE DRAWINGS

The invention is herein described, by way of example only, with reference to the accompanying drawings, wherein:

FIG. 1 is a diagram of a magnetic propulsion motor based on both attraction and repulsion.

FIG. 2 is a diagram of a magnetic propulsion motor based on repulsion.

FIG. 3 is a diagram of a timing control system.

FIG. 4 is a photo of a functioning system.

FIG. 5 is a diagram and photo of the construction of a radially oriented set of electromagnets.

FIG. 6 is a diagram of attraction and repulsion combined.

FIG. 7 is a diagram of lock and neutral positions.

FIG. 8 is a diagram of levitation of a rotor system.

### DESCRIPTION OF THE PREFERRED EMBODIMENTS

The present invention relates to devices and methods of generating continuous rotational motion from magnet sets.

Definitions: A magnetic propulsion motor is a device that produces rotational motion that can be used to generate electricity from the interaction of magnets on a rotor and on a second functionally adjacent object holding other magnets. All uses of the term here are meant to be rotational unless otherwise specified. An orientation shown as North and South in the pictures could just as well have all polarities reversed throughout the picture and throughout the descriptions.

The principles and operation of a magnetic propulsion motor according to the present invention may be better understood with reference to the drawings and the accompanying description.

According to the present inventions there are provided several devices and methods of production of electrical energy from magnetic forces.

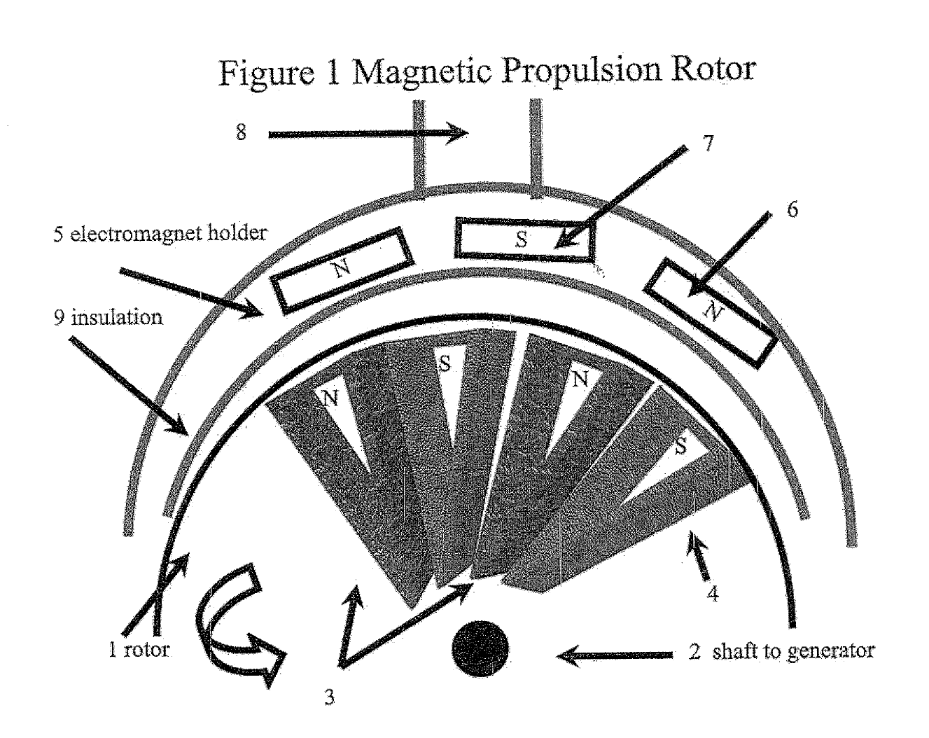

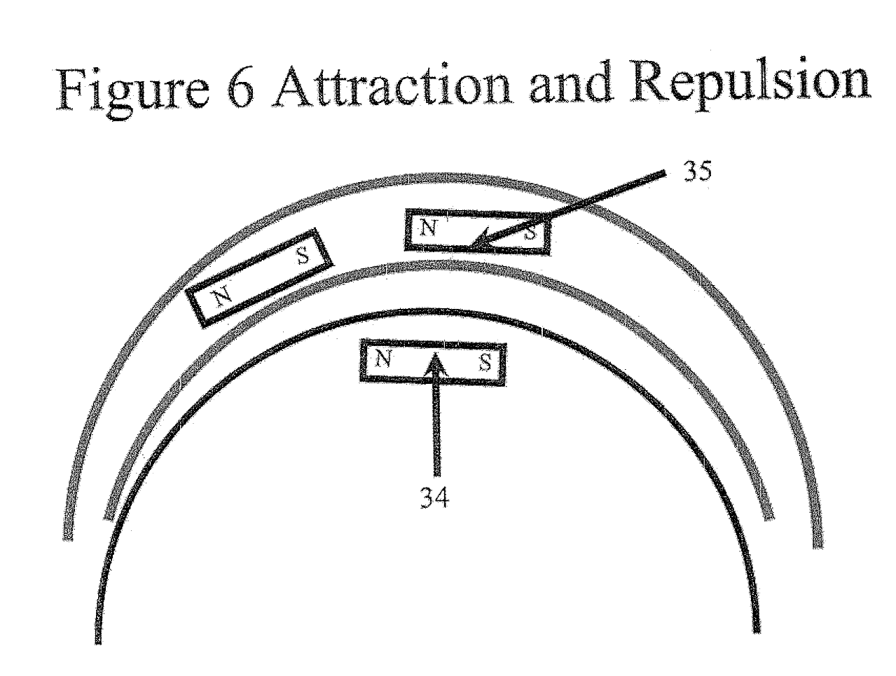

Referring now to the drawings, FIG. 1 illustrates a magnetic propulsion motor based on both attraction and repulsion using magnets each of which presents a single polarity in the direction of the rotor. (By contrast, FIG. 6 presents magnets with both polarities along the periphery of the rotor and the adjacent holder.) This is similar to the Maglev propulsion concept except that the propulsion occurs in a circular motion and there are means of increasing the input from the electromagnetic side, such as gravity and superconductivity.

It has been previously noted that a rotor configuration with magnets on one or both sides of a rotor or slider could be a basis for producing temporary energy from magnetic attraction and/or propulsion. However, certain means shown here make it possible to make this motion continuous.

FIG. 1 is a Magnetic Propulsion Motor. It shows a rotor (1) with at least one set of alternating north and south magnets (3 and 4) facing the outer side of a rotor, although other configurations are possible. At the center of the rotor is a shaft (2) that transfers rotational motion to a generator as one possible means of creating electrical current. There may be space between the magnets on the rotor, or they may be contiguous. They may be inserted in the rotor and held in place by glue or by non-glue means. The polarity shown on the magnets is the force that faces the periphery of the rotor in alternating north and south forces. The magnets on the rotor are ideally permanent magnets. Apposing the rotor (1) is a holder (5) for at least one electromagnet (6,7). The electromagnets are arranged in alternating north-south orientation towards the magnets on the rotor. The electromagnets fire in tandem. The magnets on the holder (5) fire when a specific configuration exists: The magnet of polarity “x” on the holder fires when the center area of polarity “x” on the outside of the rotor has passed the central area of the holder's magnet of polarity “x” in the direction of rotation. (This assumes even distribution of forces. If the forces are not evenly distributed, then the firing should occur when the majority of flux has passed the central area on the holder.) At the same time, the minority of the flux or area of “y” polarity is functionally adjacent to the electromagnetic of “x” and the rotor is attracted in the direction of rotation. Before the “y” magnet midline has passed the midline of the “x” on the holder, the power of the electromagnet should be eliminated. Alternate regular firing of the electromagnet will lead to smooth rotational motion. The magnets on each side are ideally located at regular intervals in order to respond to regular firing.

The above process should use more energy than it produces. We can increase the input of energy without having to increase the input electricity by placing the holder (5) superior to the rotor (1), whereby the force of gravity provides an input. At least one sliding part such as (8) in a piece that enables vertical motion enables the holder/slider to add the force of gravity via its weight to the rotation imparted to the rotor. Insulation (9) around the electromagnets would enable the use of superconductivity to minimize the amount of electricity used to induce the electromagnets. Since superconductivity leads to a point at which the electricity supplied is very low and can persist for long periods of time, one can supply very little electricity to the magnets in the holder, and cause its magnets to induce rotation in the rotor for a very long time. Ideally, the magnets in the holder are cooled and insulated, thereby enabling it to conduct electricity with minimal resistance. The holder's magnets may be a three phase current in one embodiment.

This scheme can be used from any direction and the magnets from each set can be apposed to each other in many ways. In all cases, many variations of the shapes of the apposing magnet sets are possible; the requirement is that they are in functional proximity. In all cases shown, the magnet sets can work by attraction, repulsion, or both.

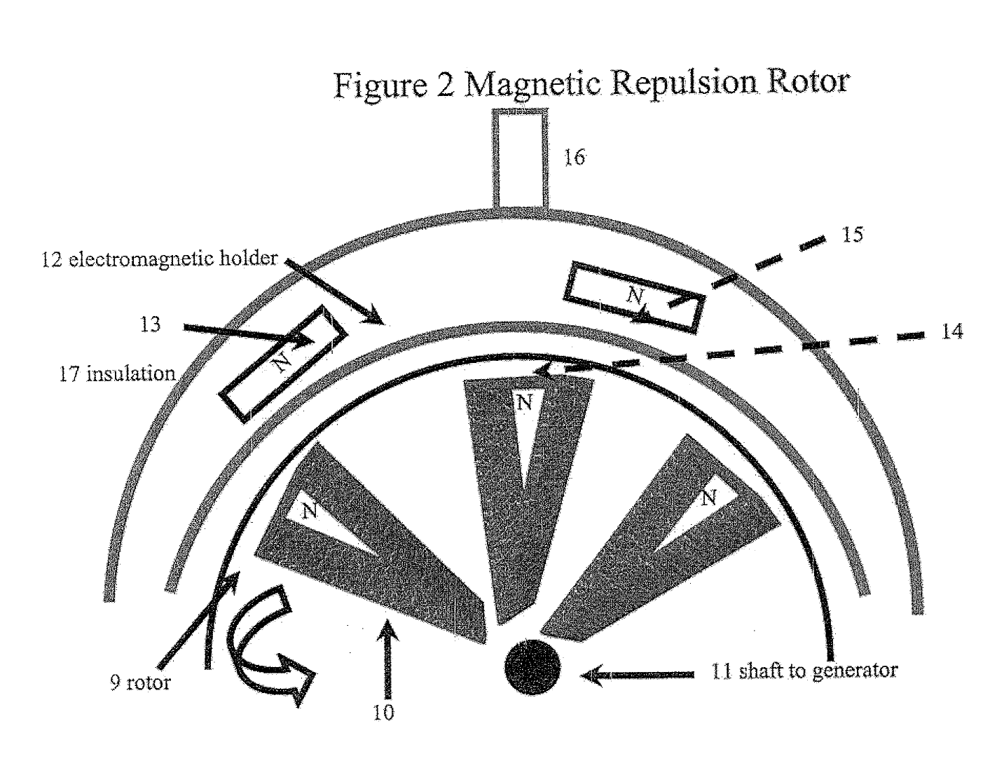

FIG. 2 shows a magnetic propulsion motor working only by repulsion. The rotor (9) contains magnets (10) facing in only one polarity toward the periphery. A shaft (11) is attached to the center to drive a generator. Apposed to the rotor is a holder (12) containing at least one electromagnet (13) with the same polarity facing the rotor. Points (14) and (15) show the centers of the magnets on each side, either physical center or magnetic flux center if the magnet is shaped irregularly or its forces are irregular. “Midpoint” is used here in a functional sense, either geometric or flux, whichever is relevant. The electromagnet should fire only after the midpoint of the rotor's magnet should pass the midpoint of the electromagnet in the direction of rotation. As in FIG. 1, orientation of the holder so it is superior to the rotor and placing it in a slider can add the force of gravity, and insulation can enable the use of superconductivity.

In a variation not shown, the electromagnets could be polarity x and the magnets of the rotor could be polarity y. In that case, the electromagnets could fire before the rotor's magnets' midpoints appose the midpoints of the holder's magnets, and stop firing before the rotor's magnets reach the mid-point of the holder's magnets.

FIGS. 1 and 2 show the orientation of the magnets when the north or south section faces the periphery of the rotor. FIG. 6 shows the orientation of the magnets when both north and south are along the periphery of the rotor and the holder. The magnets and electromagnets are arranged in orientation N-S in one magnet and N-S in the next. In that way, firing of the electromagnet occurs once the midline of the magnet (34) in its direction of rotation has passed the midline of the electromagnet (35). As shown here, the leading edge of the magnet, in this example N, is ideally repelled by the leading edge of the first electromagnet and attracted to the trailing edge of the second electromagnet. The trailing edge (S) of the magnet is repelled by the trailing edge (S) of the electromagnet and attracted to the leading edge (N) of the first electromagnet.

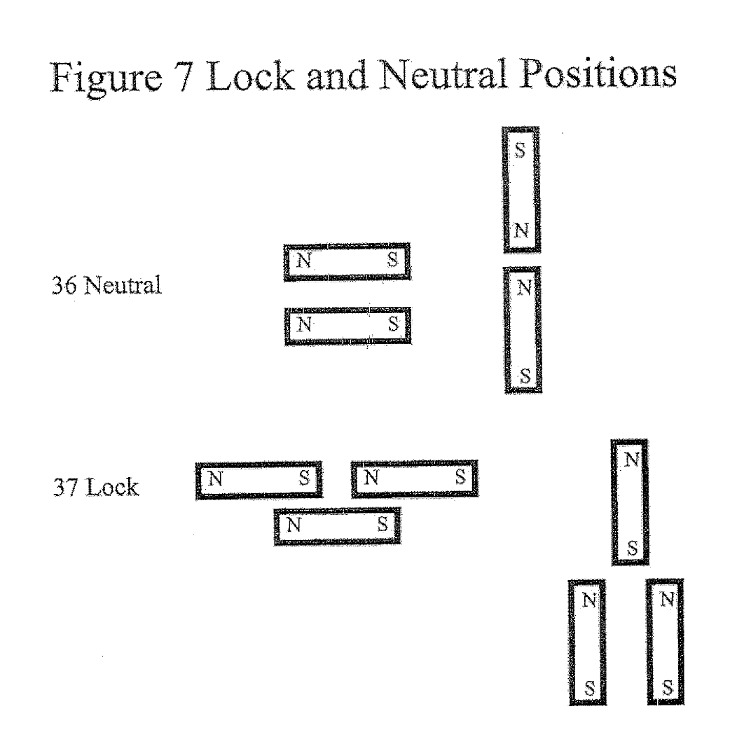

FIG. 7 shows lock (37) and neutral (36) positions. These are to be avoided for firing of the electromagnets, as they will impede the rotation. The electromagnet should operate ideally between these two locations.

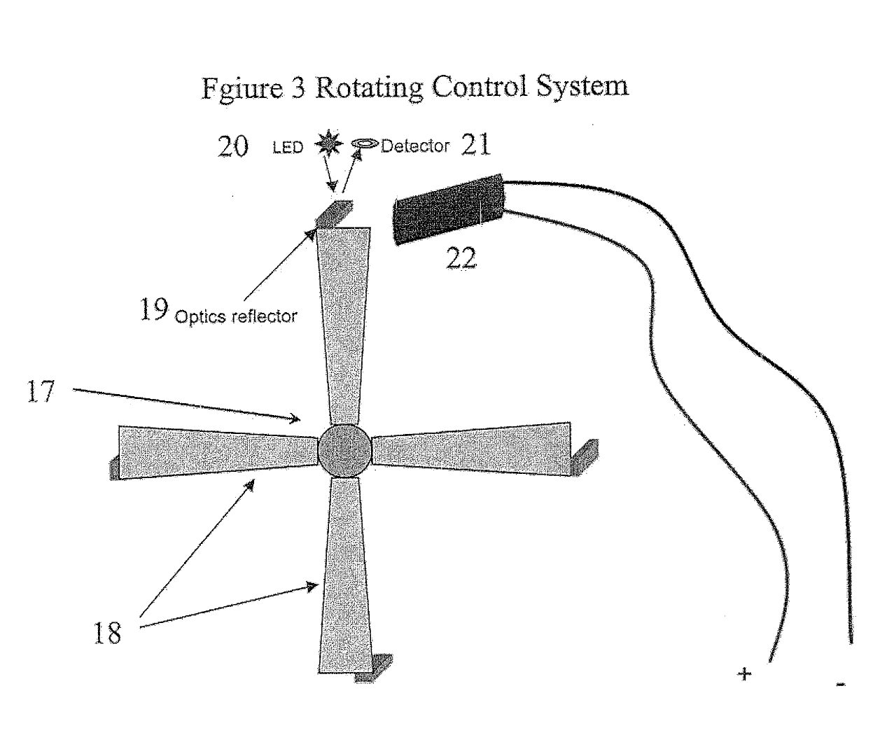

FIG. 3 illustrates the timing control system that is essential for this invention to work. It shows a device and method for ensuring that power activates the electromagnets at precisely the right time in order to create the right amount of repulsion and/or attraction. It shows a schematic rotor with a shaft (17) and at least one extension holding the magnets at the periphery (18). This is a simplified embodiment for the sake of illustration; the magnets can be held in many different designs. At least one extension, or part of the rotor, has an optics reflector (19). The system works as follows: An LED (20) provides light to the reflector, which aims it toward a detector (21) at a certain position. Said detector sends an impulse through a microprocessor with memory or similar means of control to an electromagnet (22) to activate it at exactly the appropriate time according to the criteria already mentioned for causing the rotor to spin in one direction.

The rotor need not be a literal rotor, but any fixture that is capable of spinning and holding magnets, as in the examples in FIG. 3, which has air between the magnets of the rotor.

In other configurations, the electromagnetism may be present in the rotor.

In one configuration, the LED (20) is always on, and the reflection hits the detector (21) when the rotor rotates into position.

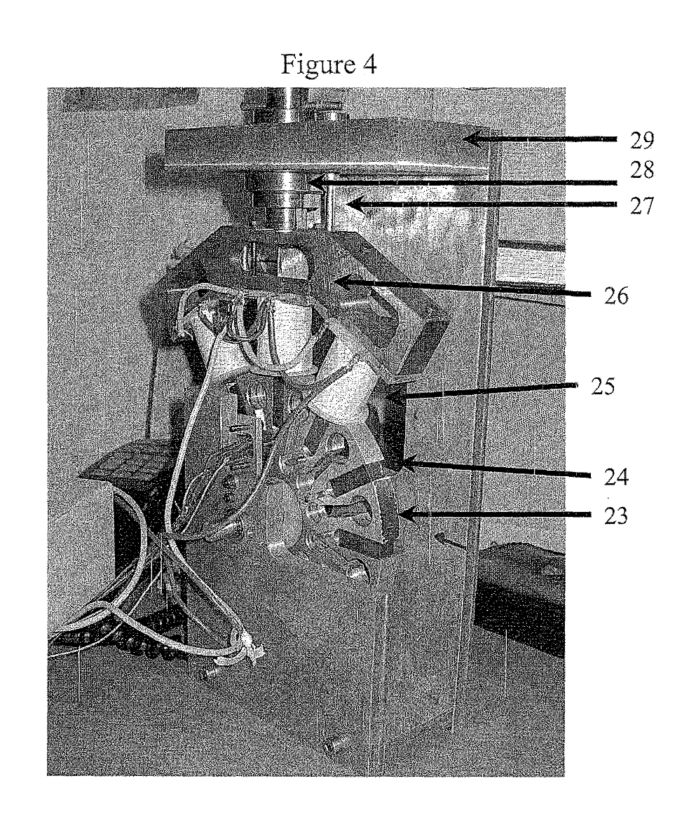

FIG. 4 shows a successfully working model of the control and repulsion systems. The rotor (23) has magnets (24) inserted into it. The rotor has holes to lighten it. The electromagnets (25) are located superior to the rotor and attached to a holder (26). The holder is allowed to slide up and down. The presence of at least two holes for the extensions (27, 28) to the holder that can slide through a supporting object (29) prevents wobble, The same could be accomplished by using a non-circular sliding extension with a matching hole.

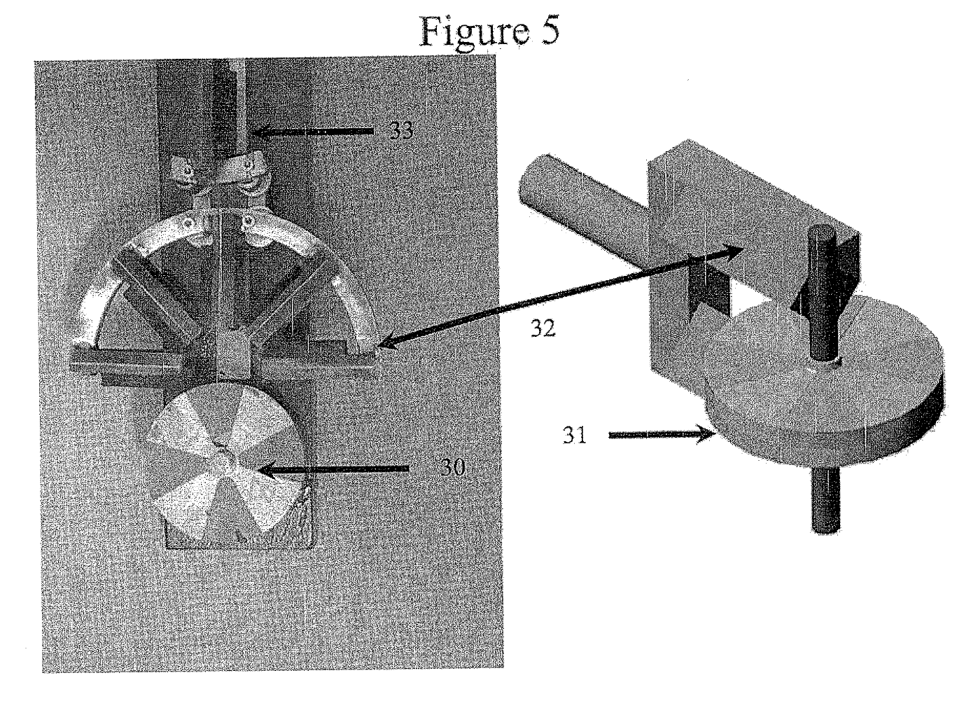

FIG. 5 shows a variation with magnets present on one or both sides of a rotor (30, 31), which has magnets on both surfaces; in one embodiment, one side presents south to the plane of the rotor and one side presents north. In the model shown, non-electric bar magnets on at least one side of the rotor represent the electromagnets (32). As in the other cases, the system can operate by attraction, repulsion, or both. When tilted appropriately, a slider (33) can allow it to operate from gravity. The electromagnets in this configuration can also be insulated and used with superconductive materials in a cold environment. So the electromagnets (32) can be above and/or below the plane of the rotor, and not just peripheral to the rotor, and the rotor magnets (31) can face above and/or below the plane of the rotor.

The method of using gravity and superconduction, alone or together, in conjunction with a maglev propulsion system, is also introduced. The method of using maglev propulsion systems in conjunction with the production of electricity is also introduced.

All positions shown may be reversed, with the electromagnet on the rotor and the magnets on the holder, but as shown, it is substantially easier to design and operate.

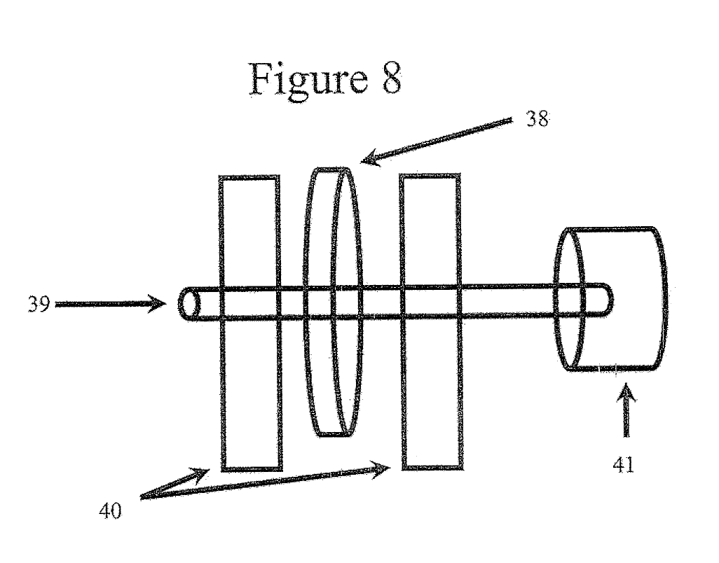

FIG. 8 shows one embodiment of levitation of said rotor system. The purpose is to decrease the friction on the rotor. In this configuration, the rotor (38) optionally has a shaft (39). Either the shaft or the rotor operate in the environment of a generator (41) to produce electricity. At any of several points in the rotor system, the rotor system may be magnetically levitated. In the diagram, the objects labeled as (40) support the shaft and would be points of levitation, but other points can be chosen.

While the invention has been described with respect to a limited number of embodiments, it will be appreciated that many variations, modifications and other applications of the invention may be made.

### SUMMARY OF THE INVENTION

The present invention successfully addresses the shortcomings of the presently known configurations by providing a magnetic propulsion generator according to several related configurations.

It is now disclosed for the first time a system for a magnetic propulsion motor, comprising:

a. a rotor with a set of at least one magnet,
b. a holder with a set of at least one electromagnet,
c. an electrical input system to the electromagnet set that activates the electromagnet periodically,
d. said rotor magnet set and said electromagnet set produce sufficient flux when substantially facing each other to rotate the rotor.

In one embodiment, the system further comprises the condition in which the magnets of the rotor magnet set are substantially equally spaced along the rotor.

In one embodiment, the system further comprises the condition in which the magnets of the holder electromagnet set are substantially equally spaced along the holder at the point at which it is adjacent to the rotor.

In one embodiment, the system further comprises the condition in which both magnet sets are substantially equally spaced.

In one embodiment, the system further comprises the condition in which the rotor rotates from only repulsion of the two magnet sets.

In one embodiment, the system further comprises the condition in which the rotor rotates from only attraction of the two magnet sets.

In one embodiment, the system further comprises the condition in which the rotor rotates from attraction and repulsion of the two magnet sets.

In one embodiment, the system further comprises the condition in which the functional section of the magnets faces the periphery of the rotor.

In one embodiment, the system further comprises the condition in which the functional section of the magnets faces at least one flat section of the rotor.

In one embodiment, the system further comprises the condition in which the functional section of the magnets faces at least one flat section of the rotor and the periphery of the rotor.

In one embodiment, the system further comprises the condition in which the electromagnet holder is superior to the rotor.

In one embodiment, the system further comprises the condition in which the holder has at least one insertion point into a supporting object in which it slides.

In one embodiment, the system further comprises the condition in which the slider shape is non-circular and matches the shape of the supporting object.

In one embodiment, the system further comprises the condition in which the orientation of polarity of the magnet sets is radial (defined as N or S being at the periphery and its opposite polarity near the center of the rotor).

In one embodiment, the system further comprises the condition in which the orientation of polarity of the magnet sets is along the periphery (defined as both N and S being adjacent to the periphery).

In one embodiment, the system further comprises the condition in which insulation surrounds the electromagnet set.

In one embodiment, the system further comprises the condition in which the magnets are superconducting magnets

In one embodiment, the system further comprises the condition in which the wires to and from the electromagnets are superconductive for at least a portion of their length.

In one embodiment, the system further comprises:

e. a generator attached to said rotor.

In one embodiment, the system further comprises:

e. an electro-optical control system for the activation of the electromagnets.

In one embodiment, the system further comprises the condition in which the electromagnets alternate south and north charges along the periphery in separate magnets for each peripheral charge.

In one embodiment, the system further comprises the condition in which the electromagnets alternate south and north charges along the periphery in magnets whose polarity is normal to the edge of the rotor.

In one embodiment, the system further comprises the condition in which the holder has a means for attaching weights.

In one embodiment, the system further comprises the condition in which the electromagnet set operates on at least one flat side of the rotor.

In one embodiment, the system further comprises:

e. glue, attaching the rotor skeleton to the magnet set.

It is now disclosed for the first time an electro-optical control system for a magnetic propulsion motor, comprising:

a. a rotor with a magnet set adjacent to an electromagnetic set on a holder,
b. a reflector, mounted on the rotor,
c. an LED or other light or electromagnetic wave source, mounted on an adjacent structure,
d. a detector, mounted on an adjacent structure,
e. a control system, electronically connected to the detector's output, and providing output to said electromagnet set.

In one embodiment, the system further comprises the condition in which the control system comprises a microprocessor.

In one embodiment, the system further comprises the condition in which the control system controls the time of the electromagnet activation.

In one embodiment, the system further comprises the condition in which the control system controls the degree of the electromagnetic activation.

In one embodiment, the system further comprises the condition in which the control system controls the time and degree of the electromagnetic activation.

It is now disclosed for the first time a method of operating a magnetic propulsion system using repulsion, wherein activation of the electromagnet occurs when the midline of the rotor magnet has passed the midline of the holder electromagnet in the direction of rotation. (“midline” defined as the magnetic center of the flux)

In one embodiment, the system further comprises the condition in which the deactivation occurs before the rotor magnet's midline has reached the midline of the next electromagnet.

It is now disclosed for the first time a method of operating a rotational magnetic propulsion system using attraction, wherein the electromagnet is deactivated during positions between and including lock and neutral in that order of rotation.

It is now disclosed for the first time a method of operating a rotational magnetic propulsion system, wherein the electromagnet is deactivated during lock positions.

It is now disclosed for the first time a method of operating a rotational magnetic propulsion system using attraction or attraction/repulsion, wherein activation of the electromagnet occurs when the midline of the magnet of the rotor in its orientation along the arc has passed the midline of the magnet of the electromagnet in the direction of rotation.

In one embodiment, the system further comprises the condition in which the deactivation occurs before the rotor magnet's midpoint reaches the midpoint between adjacent electromagnets.

It is now disclosed for the first time a method of operating a rotational magnetic propulsion system, wherein the force from gravity from the holder minus the electrical input to the electromagnets and friction/efficiency losses is greater than the force required to rotate the rotor.

In one embodiment, the system further comprises the condition in which the rotor is attached to a generator.

It is now disclosed for the first time a system for a magnetic propulsion motor, comprising:

a. a rotor with a set of at least one electromagnet,
b. a holder with a set of at least one magnet,
c. an electrical input system to the electromagnet set that activates the electromagnet periodically,
d. said rotor electromagnet set and said magnet set produce sufficient flux when substantially facing each other to rotate the rotor.

It is now disclosed for the first time a braking system for a magnetic propulsion motor, comprising:

a. a rotor with a set of at least one magnet,
b. a holder with a set of at least one electromagnet,
c. an electrical input system to the electromagnet set that activates the electromagnet periodically,
d. said activation occurs when the system is in a locked position.

In one embodiment, the system further comprises:

e. an electro-optical control system attached to the electromagnet.

It is now disclosed for the first time a system for a magnetic propulsion motor, comprising:

a. a rotor with a set of at least one magnet,
b. a surrounding ring with a set of at least one electromagnet, said surrounding ring and electromagnet set operating in an environment of superconductivity.
c. an electrical input system to the electromagnet set that activates the electromagnet periodically,
d. said rotor magnet set and said electromagnet set produce sufficient flux when substantially facing each other to rotate the rotor.

In one embodiment, the system further comprises the condition in which the magnets operate only by repulsion.

It is now disclosed for the first time a magnetic propulsion motor, comprising:

a. a rotor system comprising a rotor and optionally comprising a shaft,
b. a generator adjacent to the rotor system and operative to produce electricity from the rotation of the rotor system,
c. said rotor system is at least partially levitated by magnetic forces.

It is now disclosed for the first time a method of braking a rotational magnetic propulsion motor, wherein changing directionality of the current reverses the polarity of the electromagnets.

1-45. (canceled)

46. A system for a magnetic propulsion motor, comprising:
a. a rotor with a set of at least one magnet,
b. a holder with a set of at least one electromagnet,
c. an electrical input system to the electromagnet set that activates the electromagnet periodically,
d. at least one magnet set is substantially equally spaced,
e. said rotor magnet set and said electromagnet set produce sufficient flux when substantially facing each other to rotate the rotor.

47. The system of claim 46, wherein the rotor rotates from only repulsion or only attraction of the two magnet sets.

48. The system of claim 46, wherein the rotor rotates from attraction and repulsion of the two magnet sets.

49. The system of claim 46, wherein the electromagnet holder is superior to the rotor.

50. The system of claim 46, wherein the holder has at least one insertion point into a supporting object in which it slides in substantially straight vertical motion.

52. The system of claim 46, wherein the orientation of polarity of the magnet and/or electromagnet sets is along the periphery (defined as both N and S being adjacent to the periphery).

53. The system of claim 46, wherein insulation surrounds the electromagnet set.

54. The system of claim 46, wherein superconduction is present for at least a portion of the electrical or magnetic systems.

55. The system of claim 46, further comprising:
f. a generator attached to said rotor.

56. The system of claim 46, further comprising:
f. an electro-optical control system for the activation of the electromagnets.

57. The system of claim 46, wherein the holder comprises a means for attaching weights.

58. The system of claim 46, wherein the electromagnet set operates on at least one flat side of the rotor.

59. An electro-optical control system for a magnetic propulsion motor, comprising:
a. a rotor with a magnet set adjacent to an electromagnetic set on a holder,
b. a reflector, mounted on the rotor,
c. an LED or other light or electromagnetic source, mounted on an adjacent structure,
d. a detector, mounted on an adjacent structure,
e. a control system for the time and/or degree of the electromagnetic activation, electronically connected to the detector's output, and providing output to said electromagnet set.

60. A method of driving or braking a rotational magnetic propulsion system using repulsion, attraction, or attraction/repulsion, wherein activation of the electromagnet occurs during unlock positions and the electromagnet is deactivated during lock positions, or vice versa.

61. A system for a magnetic propulsion motor, comprising:
a. a rotor with a set of at least one electromagnet,
b. a holder with a set of at least one magnet,
c. an electrical input system to the electromagnet set that activates the electromagnet periodically,
d. said rotor electromagnet set and said magnet set produce sufficient flux when substantially facing each other to rotate the rotor.

62. A method of braking a rotational propulsion motor, wherein changing directionality of the current reverses the polarity of the electromagnets.
